(19) United States
(12) Patent Application Publication
(10) Pub. No.: US 2025/0172670 A1
(43) Pub. Date: May 29, 2025

(54) LIDAR APPARATUS

(71) Applicant: Hong Kong Applied Science and Technology Research Institute Company Limited, Hong Kong (HK)

(72) Inventors: Nicolas Michel Bernard PERNEY, Hong Kong (HK); Weiwen YU, Hong Kong (HK); Xinliang LI, Hong Kong (HK); Can LIU, Hong Kong (HK); Keng Huat KOH, Hong Kong (HK)

(21) Appl. No.: 18/518,621

(22) Filed: Nov. 24, 2023

(51) Int. Cl. G01S 7/481

(52) U.S. Cl. CPC G01S 7/4817; G01S 7/4813

(57) ABSTRACT

A LiDAR apparatus with an selective reflecting device is provided. The LiDAR apparatus comprises a laser source, an optical turning device, and a selective reflecting device. The selective reflecting device comprises a convex surface, and a selective reflecting layer disposed on the convex surface. The laser source is configured to provide a light beam. The optical turning device is configured to accept the light beam and to direct it towards the selective reflecting device. The selective reflecting layer is configured to reflect the light beam, and to allow a visible light to pass through the selective reflecting layer. The optical turning device is configured to turn the light beam and to change a position on the selective reflecting layer on the convex surface that is illuminated by the light beam.

### TECHNICAL FIELD

The present invention generally relates to light detection and ranging (LiDAR) technology and techniques comprising a selective reflecting device.

### BACKGROUND

With the development of driver assistance system or advanced driver assistance system (ADAS), vehicles are installed with optical technology used for measuring distances between objects for creating detailed 3D maps of the surrounding environment. By measuring the time a laser takes to bounce back after hitting an object, a LiDAR device can create the detailed 3D maps in real-time. LiDAR has gained significant importance in the automotive field, where it plays a crucial role in autonomous vehicles and ADAS.

There are different types of LiDAR device, which include: mechanical LiDAR, and solid-state LiDAR. Mechanical LiDAR employs spinning or oscillating mirrors to direct the laser beams in different directions. However, mechanical LiDAR devices rely on moving parts, such as spinning or oscillating mirrors, and these moving components are prone to wear and tear over time, leading to reduced reliability and potentially higher maintenance costs. Also, mechanical LiDAR devices tend to be bulkier and heavier compared to solid-state counterparts. This can pose challenges for integration into smaller or more streamlined vehicle designs.

Solid-state LiDAR uses solid-state components like microelectromechanical systems (MEMS) for beam steering. It's implementations are usually more compact and durable, but it has its own limitations. Solid-state LiDAR devices have more limited field of view (FOV) compared to that of mechanical LiDAR devices, which means they may not provide a 360-degree view of the environment without the help from additional sensors or some scanning mechanisms. The requirements of these scanning mechanisms and sensors can make them more expensive to manufacture and maintain.

As such, there is a need in the market for cost-effective solid-state LiDAR with wide FOV.

### SUMMARY OF INVENTION

It is an objective of the present invention to provide an apparatus to address the aforementioned shortcomings and unmet needs in the current state of the art. In accordance with a first aspect of the present invention, a LiDAR apparatus with an selective reflecting device is provided. The LiDAR apparatus comprises a laser source, an optical turning device, and the selective reflecting device. The selective reflecting device comprises a convex surface, and a selective reflecting layer disposed on the convex surface. The laser source is configured to provide a light beam. The optical turning device is configured to accept the light beam and direct it towards the selective reflecting device. The selective reflecting layer is configured to reflect the light beam, and to allow a visible light to pass through the selective reflecting layer. The optical turning device is configured to turn the light beam and to change a position on the selective reflecting layer on the convex surface that is illuminated by the light beam under a first scanning mode.

In an embodiment of the present invention, the optical turning device comprises a MEMS mirror. An adjustable reflecting surface of the MEMS mirror is facing towards the selective reflecting layer, and the convex surface is protruding towards the adjustable reflecting surface.

In another embodiment of the present invention, the optical turning device comprises a prism pair. The prism pair has a first angled surface facing towards the laser source, and the prism pair has a second angled surface facing towards the selective reflecting device.

In still another embodiment of the present invention, the convex surface is spherical. The radius of curvature of the convex surface ranges from 16 mm to 32 mm.

In summary, the LiDAR apparatuses of the embodiments of the present invention achieve wide FOV through the use of the selective reflecting devices having the convex surfaces. Also, while visible light passes through the selective reflecting devices, images are acquired through the selective reflecting device for further applications.

### BRIEF DESCRIPTION OF DRAWINGS

Embodiments of the invention are described in more details hereinafter with reference to the drawings, in which:

FIG. 1A depicts a schematic diagram of a LiDAR apparatus in accordance with one embodiment of the present invention;

FIG. 1B depicts a schematic diagram of an optical turning device and a selective reflecting device in accordance with one embodiment of the present invention;

FIG. 2 depicts a top-view schematic diagram of the LiDAR apparatus in accordance with one embodiment of the present invention;

FIG. 3 depicts a schematic diagram of a LiDAR apparatus in accordance with another embodiment of the present invention;

FIG. 4 depicts a schematic diagram of a LiDAR apparatus in accordance with another embodiment of the present invention;

FIG. 5 depicts a schematic diagram of a LiDAR apparatus in accordance with yet another embodiment of the present invention;

FIG. 6 depicts a schematic diagram of a case of the LiDAR apparatus in accordance with the embodiment as shown in FIG. 5;

FIG. 7 depicts a schematic diagram of a LiDAR apparatus in accordance with still another embodiment of the present invention; and

FIG. 8 depicts a schematic diagram of a LiDAR apparatus in accordance with still another embodiment of the present invention.

### DETAILED DESCRIPTION OF THE INVENTION

In the following description, apparatuses and methods for LiDAR and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

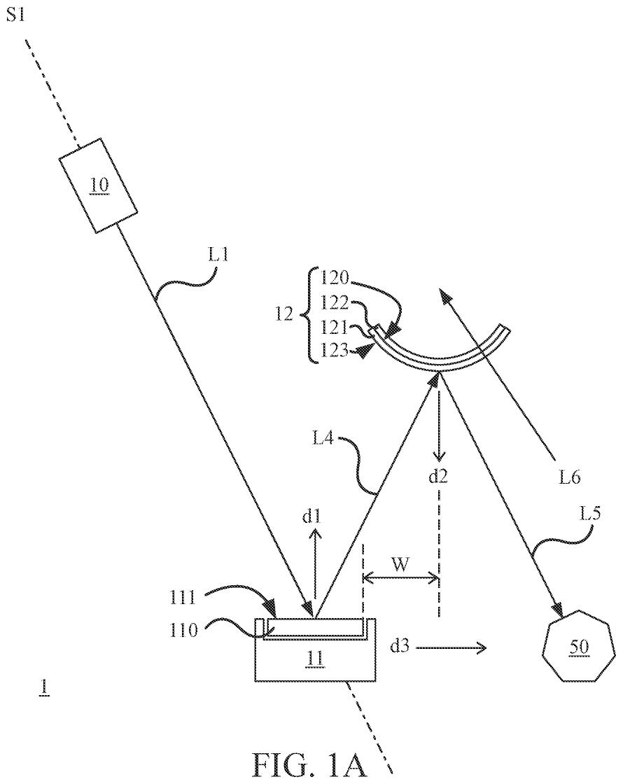

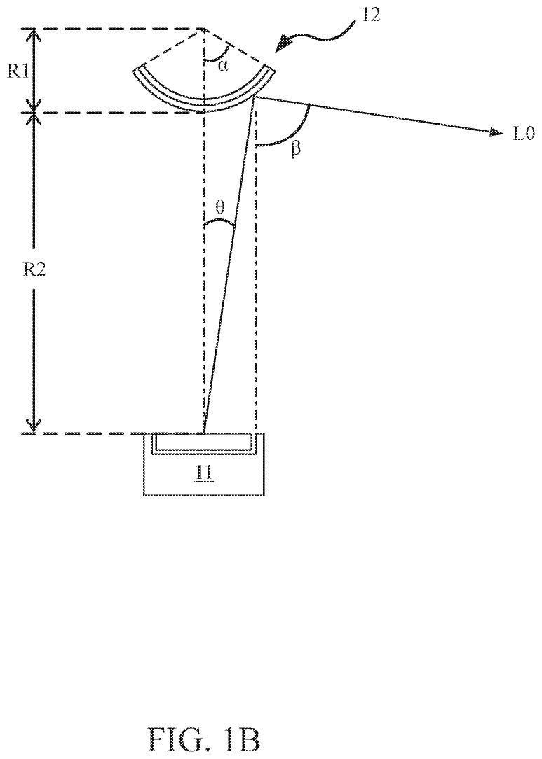

Referring to FIG. 1A for the following description. The LiDAR apparatus 1 of this embodiment comprises a laser source 10, an optical turning device 11, and a selective reflecting device 12. The selective reflecting device 12 comprises a convex surface 120, and a selective reflecting layer 121 disposed on the convex surface 120.

More specifically, the selective reflecting device 12 of this embodiment has a transmissive curved component 122. The transmissive curved component 122 provides the convex surface 120, and the selective reflecting layer 121 covers the convex surface 120 of the transmissive curved component 122.

The laser source 10 of this embodiment is configured to provide a light beam L1. In this context, the light beam encompasses both laser beams and lights of various wavelengths characterized by low divergence.

The optical turning device 11 of this embodiment is configured to redirect the light beam. The optical turning device 11 receives the light beam L1 and provides the light beam L4 towards the selective reflecting device 12. More specifically, the optical turning device 11 turns the light beam L1 into the light beam L4 with different transmitting direction. The optical turning device 11 turns the direction of the light (light beam) trough reflection, but the invention is not limited thereto. In some other embodiments, the optical turning device of the LiDAR apparatus can redirect the light beam through reflection or refraction.

The selective reflecting device 12 of this embodiment provides a selective reflection to the light beam in the LiDAR apparatus 1. In particular, the selective reflecting layer 121 is configured to reflect the light beam L4 into light beam L5, and to allow a visible light L6 to pass through the selective reflecting layer 121. The selective reflecting layer 121 is conformally formed on the transmissive curved component 122, so the selective reflecting layer 121 provide a convex selective reflecting surface 123. When light is incident upon the convex selective reflecting surface 123, it diverges from a vertical line. After reflection, the light extends over a wide range of angles with respect to the vertical, creating a broad angular distribution. The characteristic of the convex selective reflecting surface 123 enables it to disperse light effectively along a wide vertical angle upon reflection.

The optical turning device 11 is configured to steer a light beam, so to control the transmitting direction of the light beam L4. The light beam L4 is incident upon a position on the selective reflecting layer 121 on the convex surface 120, and the optical turning device 11 is configured to change the position under a first scanning mode. More specifically, the optical turning device 11 controls the transmitting direction of the light beam L4; and under the first scanning mode, the optical turning device 11 continuously changes the transmitting direction of the light beam L4. Light beam L4 incident on different positions of the selective reflecting layer 121 can illuminate various areas of the surface 123, resulting in the light beam L5 being transmitted at varied angles.

By providing the light beam L5 with the selective reflecting device 12, the light beam L5 can be incident upon an object 50. The LiDAR apparatus 1 can detect the distance between itself and the object 50 by receiving the light beam reflected back from the object 50. Since the selective reflecting layer 121 on the convex surface 120 have an outward curvature, producing diverging rays of light, the LiDAR apparatus 1 can provide wide FOV. Therefore, the LiDAR apparatus 1 of this embodiment has a broad view of the surroundings.

The selective reflecting device's 12 optical properties, such as its wide FOV, enable the LiDAR apparatus 1 to capture a broader and more comprehensive view of the surrounding environment. This enhanced FOV can lead to improved situational awareness and object detection capabilities, making the LiDAR apparatus 1 more effective in applications such as autonomous vehicles, smart lampposts, and robotics. Also, the use of a convex surface 120 and the selective reflecting layer 121 thereon simplifies the design and assembly of the LiDAR apparatus 1, potentially reducing production costs and making the LiDAR apparatus 1 more accessible for various industries and applications. The integration of the selective reflecting device 12 in the LiDAR apparatus 1 of this embodiment enhances its performance and usability, contributing to advancements in fields where precise environmental sensing and mapping are essential.

In this embodiment, the laser source 10 provides infrared radiation (IR), and the wavelength of the light beam L1 is 1550 nm, and the light beam L1 is suitable for long range detection with low beam divergence. In some embodiments, the laser source 10 is integrated with (i.e., silicon) photonics. In some other embodiments, the laser source 10 provides a frequency modulated continuous wave, which improves the signal to noise ratio of the LiDAR apparatus 1, but the invention is not limited thereto. In still some other embodiments, the wavelength of the light beam provided by the laser source 10 ranges from 800 nm to 2 μm. Therefore, the light beam provided by the LiDAR apparatus 1 would not affect other people, such as pedestrians and drivers in its surrounding environment.

In this embodiment, the transmissive curved component 122 defines the shape of the selective reflecting layer 121 and having a proper optical feature for transmitting visible light. The transmissive curved component 122 can provide structural support, and being transparent to visible light, does not interfere with the desired IR reflection. In some various embodiments of the present invention, the transmissive curved component 122 is made of one or more of glass, plastics, polymers, sapphire, quartz, transparent ceramics, and polymer films.

In particular, the convex surface 120 is spherical, and the radius of curvature of the convex surface 120 is 16 mm. Referring to FIG. 1B for the following description. The angles α, β and θ are defined as β=2^{α}+θ where

$$sin α = \frac{R 2}{R 1} \times sin θ ;$$

$$R 2 = d \times ( cos θ + {tan}^{2} θ ) .$$

While the radius of curvature R1 is 16 mm, and the angle θ is 5 degrees, the angle β can be about 75 degrees, and the light beam L0 provides a large FOV.

Therefore, the LiDAR apparatus 1 can scan a large area through the selective reflecting device 12. In some other embodiments of the present invention, the radius of curvature of the convex surface 120 ranges from 16 mm to 32 mm. By utilizing this selective reflecting device 12, the divergence of the light beam L5 is reduced, so as to provide a proper scanning with the combination of the laser source 10 and the optical turning device 11.

In this embodiment, the selective reflecting layer 121 is a selective IR reflector. The selective reflecting layer 121 reflects light having a particular wavelength, and the wavelength correspond to infrared spectrum. The selective reflecting layer 121 is an optical coating deposited on the transmissive curved component 122.

In finer detail, the selective reflecting layer 121 and the transmissive curved component 122 form a dielectric convex mirror. The selective reflecting layer 121 comprises multiple thin layers of dielectric materials, such as silicon dioxide (SiO₂), titanium dioxide (TiO₂), and tantalum pentoxide (Ta₂O₅). By careful design of the thickness and refractive index of these dielectric layers, the dielectric convex mirror can reflect certain IR wavelengths, which is the same or near the wavelength of the light provided by the laser source 10, while transmitting visible light. However, the present invention is not limited to the aforesaid materials for the selective reflecting layer 121. In some other embodiments, the selective reflecting layer 121 may comprise metamaterials, metal, or photonic crystal. In some still other embodiments, the selective reflecting layer may be dichroic filters, or interference coating.

In this embodiment, the optical turning device 11 comprises a MEMS mirror 110. The MEMS mirror 110 provide an adjustable reflecting surface 111, and the adjustable reflecting surface 111 is facing towards the selective reflecting layer 121. The convex surface 120 is protruding towards the adjustable reflecting surface 111, so as to receive the light beam L4 from the adjustable reflecting surface 111 of the optical turning device 11.

In particular, the adjustable reflecting surface 111 is a plane, and the facing direction and the normal vector of the adjustable reflecting surface 111 without being tilted extends along direction d1. The center of the convex surface 120 is protruding along direction d2. The direction d1 and the direction d2 are parallel and opposite to each other's.

In direction d3, the adjustable reflecting surface 111 and the center of the convex surface 120 retain a distance W between them, and the direction d3 is perpendicular to the direction d1. Also, the laser source 10 and the MEMS mirror 110 are aligned along a straight line S1, and the straight line S1 does not intersect the selective reflecting layer 121. The selective reflecting device 12 also retains a certain distance from the straight line S1. Therefore, through the selective reflecting device 12, the LiDAR apparatus 1 can easily detect the object 50 through reflectance between these optical devices.

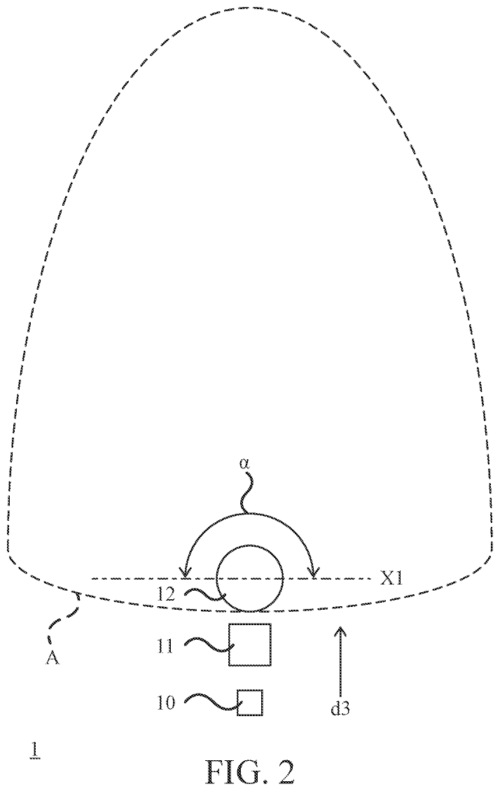

Referring to FIG. 2 for the following description. In the direction d3, the laser source 10, the optical turning device 11, and the selective reflecting device 12 are separated. With the optical feature of the selective reflecting device 12 working as a convex mirror to the light beam provided by the laser source 10, the LiDAR apparatus 1 can provide a wide detecting area A without any blind spot located therein.

With the reference of an axe X1 passing through the center of the selective reflecting device 12, the detecting area A covers at least a detecting angle α that is 180 degrees. Therefore, the LiDAR apparatus 1 achieves an optimal detection range when mounted high on the wall.

In the subsequent embodiments, the same reference characters will be used to represent identical components as illustrated in the embodiment above, eliminating the need to reiterate their details.

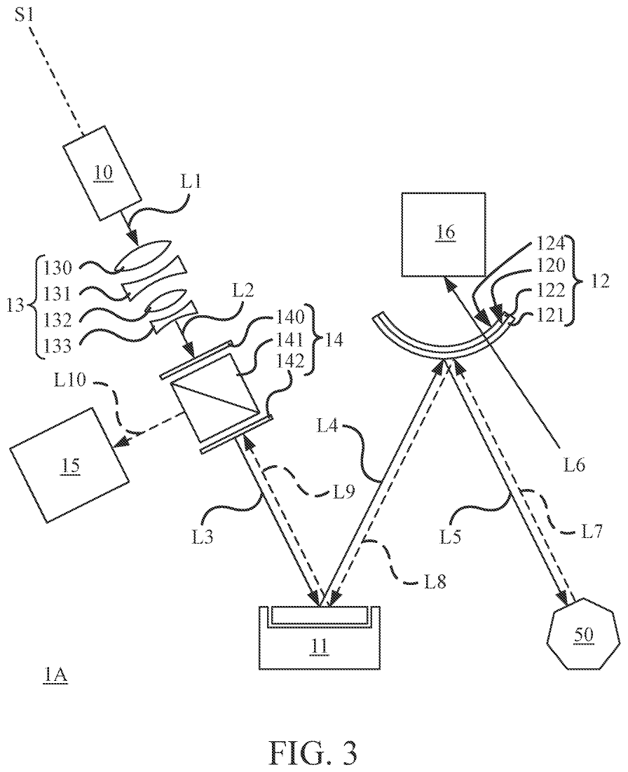

Referring to FIG. 3 for the following description. The LiDAR apparatus 1A is like the LiDAR apparatus 1 as shown in FIG. 1A. The LiDAR apparatus 1A comprises the laser source 10, the optical turning device 11, and the selective reflecting device 12. The selective reflecting device 12 has the transmissive curved component 122 and the selective reflecting layer 121 on the convex surface 120 of the transmissive curved component 122.

In this embodiment, the LiDAR apparatus 1A comprises a lens device 13. The lens device 13 is located between the laser source 10 and the optical turning device 11. The lens device 13 can mitigate the laser beams' (light beams L2, L3, L4, L5) divergence originating from the laser source 10, so as to improve the detecting resolution of the LiDAR apparatus 1A.

In particular, the lens device 13 of this embodiment has a plurality of lenses 130, 131, 132, 133. The positions of the lenses 130, 131, 132, 133 are configured to be adjustable under the first scanning mode. Under the first scanning mode, while the angle of the light beam L4 reflected by the optical turning device 11 is changing, the lenses 130, 131, 132, 133 can move along its optical axis (straight line S1) individually. Therefore, the divergence of the light beam can be compensated properly under the first scanning mode.

In this embodiment, the lens device 13 provide an active beam control through the moving lenses 130, 131, 132, 133, but the present invention is not limited thereto. In some other embodiments, the lens device 13 may comprise a collimating lens, a beam expander, a focusing lens, a holographic grating, a fiber collimator, a telescopic system, a diffractive optical element, a liquid lens, or a prism pair.

The LiDAR apparatus 1A of this embodiment comprises a beam splitting device 14 and a receiver 15. The beam splitting device 14 is disposed between the laser source 10 and the optical turning device 11, and the receiver 15 is disposed beside the beam splitting device 14. The laser source 10, the beam splitting device 14, and the optical turning device 11 are aligned along the straight line S1, and the receiver 15 is not located on the straight line S1. Therefore, the laser source 10, the beam splitting device 14, and the optical turning device 11 can have good alignment while the receiver 15 can receive light beam reflected by the object 50. Furthermore, the lens device 13 is also disposed on the straight line S1, and, by moving along the straight line S1, the lens device 13 can control the divergence of the light beam easily.

To be specific, the beam splitting device 14 of this embodiment comprises a polariser 140, a polarising beam-splitter 141, and a quarter waveplate 142. The polarising beam-splitter 141 is located between the polariser 140 and the quarter waveplate 142, and the polariser 140 is configured to receive the light beam L2 from the lens device 13, and the quarter waveplate 142 is configured to receive a light beam L9 from optical turning device 11.

In this embodiment, the laser source 10 provide a light beam L1. The lens device 13 receive the light beam L1 and provide the light beam L2 to the beam splitting device 14. The polariser 140 polarize the light beam and the light beam passes through the beam splitter 141 and the quarter waveplate 142 and provide as light beam L3. The optical turning device 11 reflect the light beam L3 into a light beam L4. The selective reflecting device 12 receives the light beam L4 and reflected it into a light beam L5, which is able to illuminate the object 50.

The object 50 redirects the incident light beam L5, resulting in the formation of a light beam L7. The selective reflecting device 12 redirects incoming light beam L7 into light beam L8. The optical turning device 11 reflects the light beam L8 into the light beam L9. After processed by the quarter waveplate 142, the polarising beam splitter 141 will reflect the light beam L9 into a light beam L10, which is adapted to be received by the receiver 15. Therefore, the LiDAR apparatus 1A provide a proper process to detect the object 50 with the light beam.

The receiver 15 of this embodiment can be an IR photodetector or an IR photodiode. In some embodiments of the present invention, the receiver 15 may include one or more of a photodiode, a phototransistor, an avalanche photodiode, an infrared sensor, a pyroelectric sensor, a silicon photomultiplier (SiPM), or a thermopile.

In this embodiment, the LiDAR apparatus 1A comprises an image sensor 16. The image sensor 16 is disposed on the back of the convex surface 120. To be specific, the transmissive curved component 122 has a concave surface 124, which is opposite to the convex surface 120, and the image sensor 16 is located in front of the concave surface 124. The image sensor 16 can capture a visible light L6 through the selective reflecting device 12.

Since the selective reflecting device 12 can only reflect the light from laser source 10, the LiDAR apparatus 1 of the embodiment has an ability to capture video covertly. The image sensor 16 behind the mirror can record video without being easily noticed by human observers, which can be useful in applications such as surveillance or monitoring where discreet operation is essential.

Also, in this embodiment, the using of the laser source 10 in conjunction with the selective reflecting device 12, the LiDAR apparatus 1A can protect the eyes and maintain a safer environment for operators and bystanders. The selective reflecting device 12 can direct the light beam as needed while keeping the visible light away from sensitive areas.

Moreover, the selective reflecting device 12 can reduce heat generation and glare, which can be especially beneficial in applications where heat buildup or reflections could be problematic.

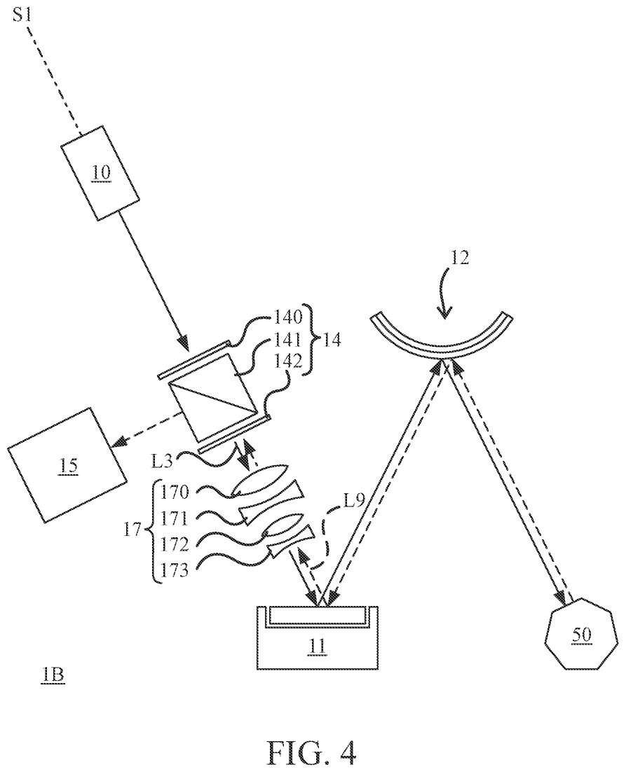

Referring to FIG. 4 for the following description. The LiDAR apparatus 1B is similar to the LiDAR apparatus 1 as shown in FIG. 1A. The LiDAR apparatus 1B comprises the laser source 10, the optical turning device 11, and the selective reflecting device 12. The LiDAR apparatus 1B also comprises the beam splitting device 14 as shown in FIG. 3.

In this embodiment, the LiDAR apparatus 1B comprises a lens device 17. The lens device 17 is located between the beam splitting device 14 and the optical turning device 11. To be specific, the lens device 17 can collimate the light beam L3 transmitted through the polarizer 140, the polarizing beam-splitter 141, and the quarter wave plate 142.

Also, the lens device 17 may expand the light beam L9 redirected by the optical turning device 11. Therefore, the intensity of the light beam can be adjusted before redirected by the polarizing beam-splitter 141 and received by the receiver 15 without causing damage.

In particular, the lens device 17 comprises a plurality of lenses 170, 171, 172, 173, and the position of the lenses 170, 171, 172, 173 are configured to be adjustable under the first scanning mode. Under the first scanning mode, while the angle of the light beam reflected by the optical turning device 11 is changing, the lenses 170, 171, 172, 173 can move along its optical axis (straight line S1) individually. Therefore, the divergence of the light beam can be compensated properly under the first scanning mode.

In this embodiment, the lens device 17 provide an active beam control through the moving lenses 170, 171, 172, 173, but the present invention is not limited thereto. In some other embodiments, the lens device 17 may comprise a collimating lens, a beam expander, a focusing lens, a holographic grating, a fiber collimator, a telescopic system, a diffractive optical element, a liquid lens, or a prism pair.

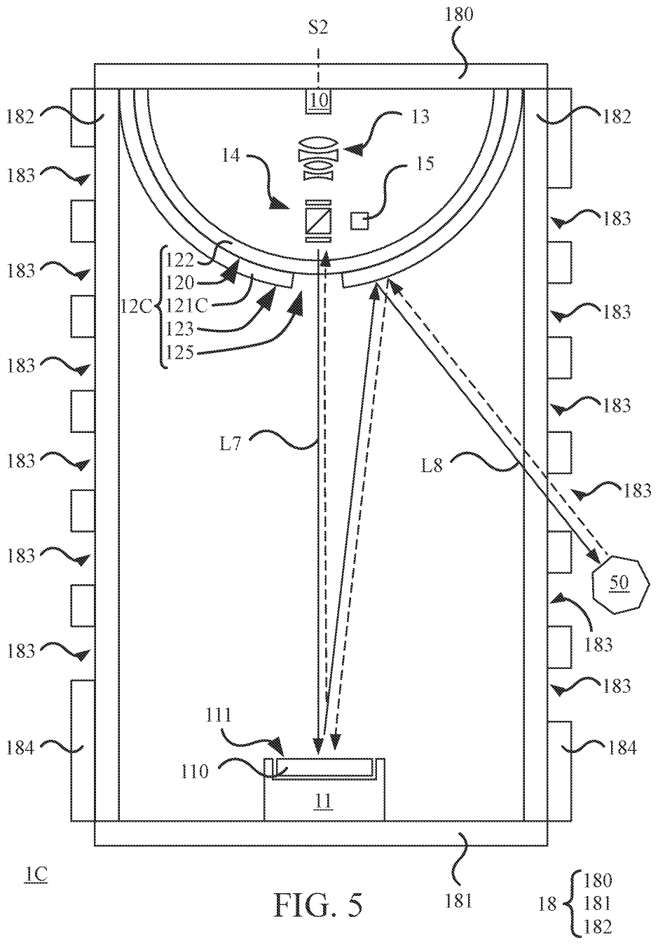

Referring to FIG. 5 for the following description. The LiDAR apparatus 1C comprises a laser source 10, an optical turning device 11, and a selective reflecting device 12C. The selective reflecting device 12C comprises a convex surface 120, and a selective reflecting layer 121C.

The convex surface 120 of this embodiment has a clear area 125, and the clear area 125 of the convex surface 120 is free from the selective reflecting layer 121C. To be specific, the selective reflecting device 12C comprise a transmissive curved component 122, and the convex surface 120 is provided by the transmissive curved component 122. The selective reflecting layer 121C is disposed on the convex surface 120 outside the clear area 125, and no selective reflecting layer 121C is disposed in the clear area 125 of the convex surface 120.

In this embodiment, the optical turning device 11 has a MEMS mirror 110, and an adjustable reflecting surface 111 of the MEMS mirror 110 is facing towards the selective reflecting layer 121C, and the convex surface 120 is protruding towards the adjustable reflecting surface 111.

The MEMS mirror 110 of this embodiment is located in front of the convex surface 120, and the laser source 10 is located on the back of the convex surface 120. The clear area 125 is located between the laser source 10 and the MEMS mirror 110 of the optical turning device 11, and the laser source 10, the clear area 125 of the convex surface 120, and the MEMS mirror 110 are aligned on a straight line S2. Because there is no selective reflecting layer 121C disposed on the clear area 125, the light beam L7 can easily transmit through the selective reflecting device 12C and reach the optical turning device 11, and, by redirecting the light beam towards the selective reflecting layer 121C, the light beam can reach the object 50.

In this embodiment, the laser source 10 can be disposed on the back of the convex surface 120. Therefore, the LiDAR apparatus 1C is compact. The LiDAR apparatus 1C can be install on the top of a smart lamppost, and the blind spot created by the clear area 125 of the convex surface 120 is corresponding to the lamppost right beneath the LiDAR apparatus 1C. Therefore, the LiDAR apparatus 1C can provide a 360-degree surveillance of the surrounding environment.

In this embodiment, the LiDAR apparatus 1C comprises a case 18. The case 18 comprises a top wall 180, a bottom wall 181, and a cylinder wall 182. The bottom wall 181 is directly beneath the top wall 180, and the cylinder wall 182 connects the top wall 180 and the bottom wall 181.

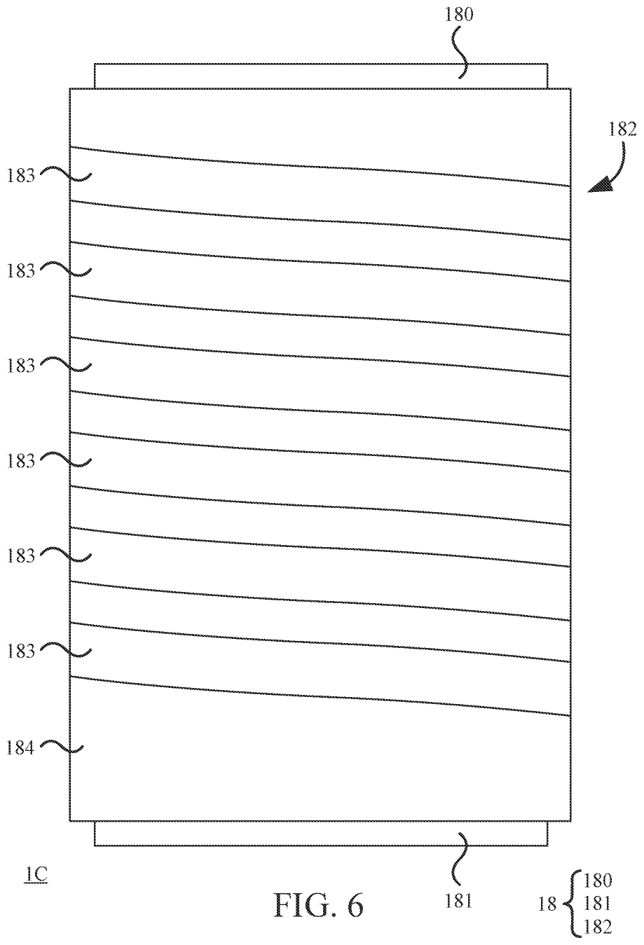

The cylinder wall 182 of this embodiment has a clear (or transparent) area 183, and the clear area 183 forms a spiral circling the inner space of the case 18. FIG. 6 depicts a schematic diagram of the case 18 of the LiDAR apparatus 1C in accordance with one embodiment of the present invention. In this embodiment, the clear area 183 forms a spiral circling the case 18. However, the dimensions, shapes, and densities of the components shown in FIG. 6 are magnified for clarity in the illustration of the concept of the present invention only. An ordinarily-skilled person in the art will appreciate that other the present invention may readily adopt components of other dimensions, shapes, or densities undue experimentation or deviation from the spirit of the present invention.

The shape of the clear area 183 is corresponding to the scanning route of the light beam L8 as shown in FIG. 5, and the rest of the cylinder wall 182 is covered by a selective reflecting layer 184. There selective reflecting layer 184 is configured to reflect the light having the similar wavelength as the light beam L8. Therefore, most of the light having the similar wavelength from the environment can be reduced in the case 18, and the noise acquire by the receiver 15 can be reduced as well.

In this embodiment, the laser source 10 and the selective reflecting device 12C are disposed on the top wall 180, and the optical turning device 11 is disposed on the bottom wall 181. Therefore, the LiDAR apparatus 1C is easy to assemble.

Furthermore, the selective reflecting device 12C of this embodiment covers the laser source 10, the lens device 13, the beam splitting device 14, and the receiver 16, so the laser source 10, the lens device 13, the beam splitting device 14, and the receiver 16 are well protected.

Also, the top wall 180 is made of metal, so the top wall 180 can dissipate heat generated by the laser source 10.

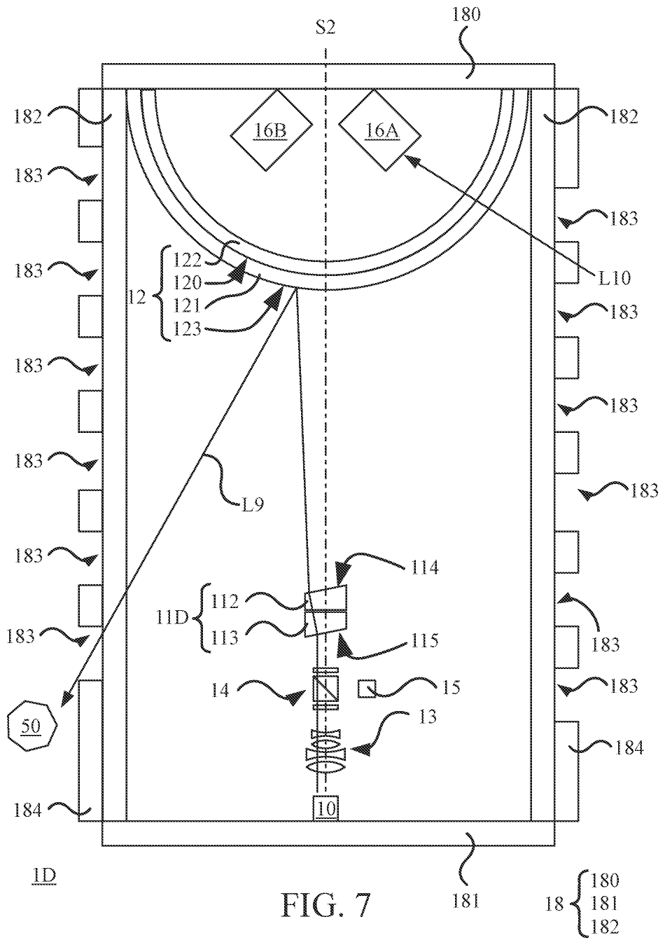

Referring to FIG. 7 for the following description. the LiDAR apparatus 1D of this embodiment comprises a laser source 10, a lens device 13, a beam splitting device 14, a receiver 15, an optical turning device 11D, and a selective reflecting device 12.

The selective reflecting device 12, the optical turning device 11D, the beam splitting device 14, the lens device 13, and the laser source 10 are arranged along a straight line S2. The optical turning device 11D is located between the selective reflecting device 12 and the beam splitting device 14, and the beam splitting device 14 is located between the optical turning device 11D and the lens device 13, and the lens device 13 is located between the beam splitting device 14 and the laser source 10. The receiver 15 is located besides the beam splitting device 14, and the receiver 15 is not located on the straight line S2.

The selective reflecting device 12 of this embodiment comprises selective reflecting layer 121, and the transmissive curved component 122. The transmissive curved component 122 provide a convex surface 120 protruding towards the laser source 10, and the convex surface 120 is covered by the selective reflecting layer 121, so the selective reflecting layer 121 provide a convex selective reflecting surface 123.

In this embodiment, the optical turning device 11D comprises a prism pair. The prism pair has a prism 112, and a prism 113. The prism 113 has an angled surface 115 facing towards the laser source 10, and the prism 112 has an angled surface 114 facing towards the selective reflecting device 12.

In this embodiment, the prism 113 has a wedge angle of 10.5 degrees, a thickness of 4 mm, and a diameter of 5 mm. The prism 112 has a wedge angle of 10.3 degrees, a thickness of 4 mm, and a diameter of 5 mm. Therefore, the combination of the laser source 10 and the prism pair would not provide a light beam with 0-degree incident angle. Also, the prisms 112, 113 is N-BK7 prisms. However, the present invention is not limited to the aforesaid type of prisms. An ordinarily-skilled person in the art will appreciate that the present invention may utilize other types of prisms without undue experimentation or deviation from the spirit of the present invention.

The prisms 112, 113 are configured to redirect the light beam L9 to reach the selective reflecting layer 121 away from its center. After reflected by the selective reflecting layer 121, the light beam L9 is used to detect the object 50.

The LiDAR apparatus 1D of this embodiment further comprises a case 18, and image sensors 16A, 16B. The case 18 comprises a top wall 180, a bottom wall 181, and a cylinder wall 182 connecting the top wall 180 and the bottom wall 181. The image sensors 16A, 16B and the selective reflecting device 12 are disposed on the top wall 180, and the image sensors 16A, 16B are covered and protected by the selective reflecting device 12.

On the outside of the cylinder wall 182, a selective reflecting layer 184 is disposed in this embodiment. A visible light L10 can transmit through the selective reflecting layer 184, the selective reflecting layer 121, and the transmissive curved component 122, so the image sensors 16A, 16B can acquire image around the LiDAR apparatus 1D.

The cylinder wall 182 has a clear (or transparent) area 183, and no selective reflecting layer 184 is disposed thereon. The clear area 183 provide a scanning route for the light beam L9 generated by the laser source 10, and the selective reflecting layer 184 effectively blocks most of the ambient light with wavelengths similar to the light beam L9.

In this embodiment, the laser source 10, the lens device 13, the beam splitting device 14, the receiver 15, and the optical turning device 11D are disposed on the bottom wall 181, and the selective reflecting device 12 is disposed on the top wall 180. As such, the LiDAR apparatus 1D is relatively easy to assemble.

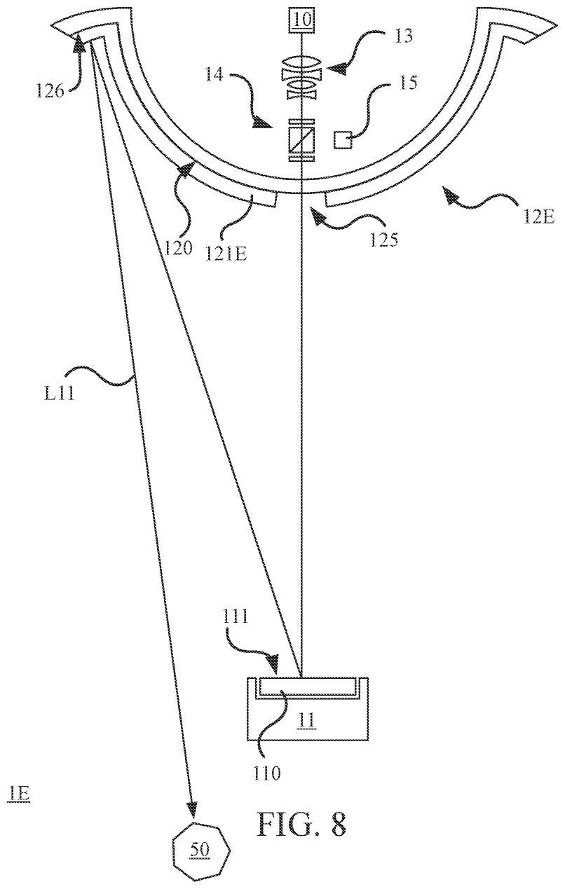

Referring to FIG. 8 for the following description. The LiDAR apparatus 1E of this embodiment comprises a laser source 10, a lens device 13, a beam splitting device 14, a receiver 15, an optical turning device 11, and a selective reflecting device 12E.

The selective reflecting device 12E of this embodiment has a focusing surface 126. The focusing surface 126 surrounds the convex surface 120. The selective reflecting layer 121E covers the focusing surface 126.

In this embodiment, the focusing surface 126 is a concave surface facing towards the tip of the convex surface 120. When a parallel light illuminates the focusing surface 126, a focus can be formed. In other words, the selective reflecting device 12E of this embodiment shaped like a hat. While the convex surface 120 corresponds to the crown of the hat protruding upward, the focusing surface 126 form the raising brim of the hat.

The operation of the LiDAR apparatus 1E of this embodiment comprises a second scanning mode following the first scanning mode. While the adjustable reflecting surface 111 of the MEMS mirror 110 of the optical turning device 11 redirect the light beam towards the convex surface 120 under the first scanning mode, the adjustable reflecting surface redirects the light beam L11 towards the focusing surface 126 under the second scanning mode. Therefore, the light L11 can detect the object in the blind area formed by the clear area 125, so as to increase the scanning area of the LiDAR apparatus 1E.

The functional units and modules of the apparatuses, systems, and/or methods in accordance with the embodiments disclosed herein may be implemented using computer processors or electronic circuitries including but not limited to application specific integrated circuits (ASIC), field programmable gate arrays (FPGA), central processing units (CPU), graphics processing units (GPU), microcontrollers, and other programmable logic teaching aids configured or programmed according to the teachings of the present disclosure. Computer instructions or software codes running in the computing teaching aids, computer processors, or programmable logic teaching aids can readily be prepared by practitioners skilled in the software or electronic art based on the teachings of the present disclosure.

The embodiments may include computer storage media, transient and non-transient memory teaching aids having computer instructions or software codes stored therein, which can be used to program or configure the computing teaching aids, computer processors, or electronic circuitries to perform any of the processes of the present invention. The storage media, transient and non-transient memory teaching aids can include, but are not limited to, floppy disks, optical discs, Blu-ray Disc, DVD, CD-ROMs, and magneto-optical disks, ROMs, RAMs, flash memory teaching aids, or any type of media or teaching aids suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing teaching aids interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A light detection and ranging (LiDAR) apparatus, comprising:
a laser source;
an optical turning device; and
a selective reflecting device comprising:
a convex surface; and
a selective reflecting layer disposed on the convex surface;
wherein the laser source is configured to provide a light beam;
wherein the optical turning device is configured to accept the light beam and to direct it towards the selective reflecting device;
wherein the selective reflecting layer is configured to reflect the light beam, and to allow a visible light to pass through; and
wherein the optical turning device is configured to turn the light beam and to change a position on the selective reflecting layer on the convex surface that is illuminated by the light beam under a first scanning mode.

2. The LiDAR apparatus of claim 1, wherein a wavelength of the light beam from the laser source ranges from 800 nm to 2 μm.

3. The LiDAR apparatus of claim 1 further comprising a first lens device, wherein the first lens device is located between the laser source and the optical turning device.

4. The LiDAR apparatus of claim 3, wherein the first lens device comprises a plurality of first lenses, and the positions of the first lenses are configured to be adjustable under the first scanning mode.

5. The LiDAR apparatus of claim 1 further comprising:
a beam splitting device disposed between the laser source and the optical turning device; and
a receiver disposed beside the beam splitting device,
wherein the laser source, the beam splitting device, and the optical turning device are aligned along a first straight line, and the receiver is not located on the first straight line.

6. The LiDAR apparatus of claim 5 further comprising a second lens device, wherein the second lens device is located between the beam splitting device and the optical turning device.

7. The LiDAR apparatus of claim 6, wherein the second lens device comprises a plurality of second lenses, and the positions of the second lenses are configured to be adjustable under the first scanning mode.

8. The LiDAR apparatus of claim 1, wherein the optical turning device comprises a MEMS mirror, and an adjustable reflecting surface of the MEMS mirror is facing towards the selective reflecting layer, and the convex surface is protruding towards the adjustable reflecting surface.

9. The LiDAR apparatus of claim 8, wherein the laser source and the MEMS mirror are aligned along a second straight line, and the second straight line does not intersect the selective reflecting layer.

10. The LiDAR apparatus of claim 8, wherein the convex surface comprises a first clear area, and the first clear area of the convex surface is free from the selective reflecting layer, and the MEMS mirror is located in front of the convex surface, and the laser source is located on the back of the convex surface, and the first clear area is located between the laser source and the optical turning device.

11. The LiDAR apparatus of claim 1, wherein the optical turning device comprises a prism pair, and the prism pair has a first angled surface facing towards the laser source, and the prism pair has a second angled surface facing towards the selective reflecting device.

12. The LiDAR apparatus of claim 1, wherein the convex surface is spherical, and the radius of curvature of the convex surface ranges from 16 mm to 32 mm.

13. The LiDAR apparatus of claim 1 further comprising an image sensor disposed on the back of the convex surface.

14. The LiDAR apparatus of claim 1 further comprising a case, wherein the case comprises:
a top wall;
a bottom wall being directly beneath the top wall; and
a cylinder wall connecting the top wall and the bottom wall, the cylinder wall has a second clear area, and the second clear area forms a spiral circling the inner space of the case.

15. The LiDAR apparatus of claim 14, wherein the laser source and the selective reflecting device are disposed on the top wall, and the optical turning device is disposed on the bottom wall.

16. The LiDAR apparatus of claim 15, wherein the selective reflecting device covers the laser source.

17. The LiDAR apparatus of claim 14, wherein the laser source and the optical turning device are disposed on the bottom wall, and the selective reflecting device is disposed on the top wall.

18. The LiDAR apparatus of claim 1, wherein the selective reflecting device has a focusing surface surrounding the convex surface, the selective reflecting layer covers the focusing surface.

19. The LiDAR apparatus of claim 18, wherein the optical turning device is configured to turn the light beam and to change a position on the selective reflecting layer on the focusing surface that is illuminated by the light beam in a second scanning mode following the first scanning mode.
